(19) United States
(12) Patent Application Publication
(10) Pub. No.: US 2024/0246095 A1
(43) Pub. Date: Jul. 25, 2024

(54) CENTRIFUGAL SEPARATOR INCLUDING AN INTEGRATED PARTICULATE FILTER

(71) Applicant: Fluid Cooling Systems, LLC, Burton, MI (US)

(72) Inventor: Robert Antaya, Rochester Hills, MI (US)

(73) Assignee: Fluid Cooling Systems, LLC, Burton, MI (US)

(21) Appl. No.: 18/157,372

(22) Filed: Jan. 20, 2023

(51) Int. Cl. B04C 9/00; B01D 29/00; B01D 29/64; B01D 29/96; B04C 5/04; B04C 5/103; B04C 5/18

(52) U.S. Cl. CPC B04C 9/00; B01D 29/0097; B01D 29/6438; B01D 29/96; B04C 5/04; B04C 5/103; B04C 5/18; B01D 2201/02; B01D 2201/287; B04C 2009/004

(57) ABSTRACT

A system for mechanical separation of a fluid is provided. The system includes a centrifugal separator configured for receiving a flow of the fluid including a plurality of solid particles and utilizing centrifugal force to separate a first portion of the plurality of solid particles from the flow of the fluid. The system further includes a particulate filter including a filter body. The particulate filter is configured for receiving the flow of the fluid from the centrifugal separator and utilizing the filter body to separate a second portion of the plurality of solid particles from the flow of the fluid.

### INTRODUCTION

The disclosure generally relates to a system for a centrifugal separator including an integrated particulate filter.

A centrifugal separator is a device useful for mechanical separation of suspended particles or debris within a fluid. The fluid is made to flow through the centrifugal separator. Within the centrifugal separator, the fluid is made to rotate or undergo angular acceleration configured for causing a centrifugal force to be applied upon the suspended particles within the fluid. The fluid is made to flow in a pattern configured for causing the suspended particles to settle in a portion of the centrifugal separator for later collection. In one embodiment, a centrifugal separator may be described as a device having a set of directional blades for preventing fluid entering the centrifugal separator from taking the path of least resistance down the inside of the body while maintaining the spinning of the fluid.

A particulate filter is a device useful for mechanical separation of suspended particles or debris within a fluid. The fluid is made to flow through the particulate filter. The fluid is made to flow through a filter which may be described as a mesh or a strainer, where the fluid may flow through the filter, and a portion of the suspended particles larger than a mesh size of the filter is removed from the fluid and deposited in a portion of the particulate filter for later collection.

### SUMMARY

A system for mechanical separation of a fluid is provided. The system includes a centrifugal separator configured for receiving a flow of the fluid including a plurality of solid particles and utilizing centrifugal force to separate a first portion of the plurality of solid particles from the flow of the fluid. The system further includes a particulate filter including a filter body. The particulate filter is configured for receiving the flow of the fluid from the centrifugal separator and utilizing the filter body to separate a second portion of the plurality of solid particles from the flow of the fluid.

In some embodiments, the centrifugal separator is configured for separating the first portion of the plurality of solid particles from the flow with relatively large particle sizes. The particulate filter is configured for separating the second portion of the plurality of solid particles from the flow with relatively small particle sizes which are smaller than the relatively large particle sizes.

In some embodiments, the centrifugal separator is configured for separating the first portion of the plurality of solid particles from the flow with relatively large masses. The particulate filter is configured for separating the second portion of the plurality of solid particles from the flow with relatively small masses which are smaller than the relatively large masses.

In some embodiments, the particulate filter is configured for enabling a user to switch from using one filter body within the particulate filter to using a second filter body within the particulate filter.

In some embodiments, the filter body is conical shaped. The filter body is oriented with a narrow end of the filter body in a vertically upward direction.

In some embodiments, the filter body defines a first portion of the particulate filter below the filter body and a second portion of the particulate filter above the filter body. The particulate filter is configured for receiving the flow of the fluid within the first portion of the particulate filter.

In some embodiments, the centrifugal separator includes a cylindrical body and an inlet pipe offset from a center of the cylindrical body and configured for creating a swirling pattern in the flow of the fluid within the cylindrical body. The centrifugal separator further includes a discharge pipe including a first end located within the cylindrical body and a second end projecting out of the cylindrical body and defining an outlet pipe of the centrifugal separator. The centrifugal separator further includes a plurality of blades disposed upon an outer surface of the discharge pipe and configured for directing the flow of the fluid from the inlet pipe to the first end of the discharge pipe. The particulate filter is attached to the outlet pipe.

In some embodiments, the centrifugal separator includes a discharge pipe configured for periodically purging the first portion of the plurality of solid particles from the centrifugal separator.

In some embodiments, the particulate filter includes a discharge pipe configured for periodically purging the second portion of the plurality of solid particles from the particulate filter.

According to one alternative embodiment, a system for mechanical separation of a fluid. The system includes a centrifugal separator configured for receiving a flow of the fluid including a plurality of solid particles and utilizing centrifugal force to separate a first portion of the plurality of solid particles from the flow of the fluid. The centrifugal separator includes a cylindrical body and an inlet pipe offset from a center of the cylindrical body and configured for creating a swirling pattern in the flow of the fluid within the cylindrical body. The centrifugal separator further includes a discharge pipe including a first end located within the cylindrical body and a second end projecting out of the cylindrical body and defining an outlet pipe of the centrifugal separator. The centrifugal separator further includes a plurality of blades disposed upon an outer surface of the discharge pipe and configured for directing the flow of the fluid from the inlet pipe to the first end of the discharge pipe. The system further includes a particulate filter including a filter body. The particulate filter is configured for receiving the flow of the fluid from the centrifugal separator and utilizing the filter body to separate a second portion of the plurality of solid particles from the flow of the fluid. The filter body is conical shaped. The filter body is oriented with a narrow end of the filter body in a vertically upward direction.

In some embodiments, the filter body defines a first portion of the particulate filter below the filter body and a second portion of the particulate filter above the filter body. The particulate filter is configured for receiving the flow of the fluid within the first portion of the particulate filter.

In some embodiments, the centrifugal separator is configured for separating the first portion of the plurality of solid particles from the flow with relatively large particle sizes. The particulate filter is configured for separating the second portion of the plurality of solid particles from the flow with relatively small particle sizes which are smaller than the relatively large particle sizes.

In some embodiments, the centrifugal separator is configured for separating the first portion of the plurality of solid particles from the flow with relatively large masses. The particulate filter is configured for separating the second portion of the plurality of solid particles from the flow with relatively small masses which are smaller than the relatively large masses.

In some embodiments, the particulate filter is configured for enabling a user to switch from using one filter body within the particulate filter to using a second filter body within the particulate filter.

According to one alternative embodiment, a system for mechanical separation of a fluid is provided. The system includes a centrifugal separator configured for receiving a flow of the fluid including a plurality of solid particles and utilizing centrifugal force to separate a first portion of the plurality of solid particles from the flow of the fluid. The system further includes a particulate filter including a filter body. The particulate filter is configured for receiving the flow of the fluid from the centrifugal separator and utilizing the filter body to separate a second portion of the plurality of solid particles from the flow of the fluid. The centrifugal separator is configured for separating the first portion of the plurality of solid particles from the flow with relatively large particle sizes. The particulate filter is configured for separating the second portion of the plurality of solid particles from the flow with relatively small particle sizes which are smaller than the relatively large particle sizes. The particulate filter is configured for enabling a user to switch from using one filter body within the particulate filter to using a second filter body within the particulate filter.

In some embodiments, the filter body is conical shaped. The filter body is oriented with a narrow end of the filter body in a vertically upward direction.

In some embodiments, the filter body defines a first portion of the particulate filter below the filter body and a second portion of the particulate filter above the filter body. The particulate filter is configured for receiving the flow of the fluid within the first portion of the particulate filter.

In some embodiments, the centrifugal separator includes a cylindrical body and an inlet pipe offset from a center of the cylindrical body and configured for creating a swirling pattern in the flow of the fluid within the cylindrical body. The centrifugal separator further includes a discharge pipe including a first end located within the cylindrical body and a second end projecting out of the cylindrical body and defining an outlet pipe of the centrifugal separator. The centrifugal separator further includes a plurality of blades disposed upon an outer surface of the discharge pipe and configured for directing the flow of the fluid from the inlet pipe to the first end of the discharge pipe. The particulate filter is attached to the outlet pipe.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 schematically illustrates an exemplary system including a centrifugal separator that provides mechanical separation of suspended particles or debris within a fluid and a particulate filter, in accordance with the present disclosure;

FIG. 2 schematically illustrates in side view an alternative centrifugal separator 10, in accordance with the present disclosure;

FIG. 3 schematically illustrates the centrifugal separator of FIG. 2 in front cross-sectional view, in accordance with the present disclosure;

FIG. 4 schematically illustrates the centrifugal separator of FIG. 2 in top cross-sectional view, in accordance with the present disclosure;

FIG. 5 schematically illustrates the centrifugal separator of FIG. 2 in top view, in accordance with the present disclosure;

FIG. 6 schematically illustrates the centrifugal separator of FIG. 2 in perspective view, in accordance with the present disclosure;

FIG. 7 schematically illustrates in perspective view the particulate filter of FIG. 1, in accordance with the present disclosure;

FIG. 8 schematically illustrates in cross sectional view the particulate filter of FIG. 7, in accordance with the present disclosure;

FIG. 9 schematically illustrates the filter body including a plate with a plurality of edge surfaces, each edge surface defining a relatively large perforation or through-hole through which a fluid may pass, in accordance with the present disclosure;

FIG. 10 schematically illustrates the filter body including a plate with a plurality of edge surfaces, each edge surface defining a relatively small perforation or through-hole through which a fluid may pass, in accordance with the present disclosure;

FIG. 11 schematically illustrates the filter body including a screen including a cross-hatch pattern of wires oriented in a first direction and wires oriented in a second direction, the wires defining relatively large mesh openings, in accordance with the present disclosure;

FIG. 12 schematically illustrates the filter body including a screen including a cross-hatch pattern of wires oriented in a first direction and wires oriented in a second direction, the wires defining relatively small mesh openings, in accordance with the present disclosure; and

FIG. 13 schematically illustrates an exemplary alternative system including a centrifugal separator that provides mechanical separation of suspended particles or debris within a fluid and a particulate filter, wherein the centrifugal separator is free of internal blades, in accordance with the present disclosure.

### DETAILED DESCRIPTION

It is often desirable to separate solid particles from liquid/solid mixtures or slurries to clarify or purify the remaining liquid. When significant quantities of solids are present, it is impractical to use mesh filters since they will quickly clog and be rendered useless. As a result, cyclonic, centrifugal liquid-solid centrifugal separators have been developed.

A high-speed rotating flow is established within a cylindrical or conical container. Material flows in a helical pattern, typically beginning at the top of the centrifugal separator and ending at the bottom end before exiting the centrifugal separator in a stream through the center of the cyclone and out the top.

The centrifugal separator utilizes centrifugal force and gravity to achieve varying degrees of separation of solid particles from a solid/liquid mixture. The separated solid particles generally settle to the bottom of the centrifugal chamber from which they are periodically removed.

A centrifugal separator may separate a majority of the solid particles from the flow. A second or sequential filter may be utilized to further separate solid particles from the flow. In one embodiment, a particulate filter may be connected to or formed unitarily with an outlet pipe of the centrifugal separator. A system is provided including a centrifugal separator that provides mechanical separation of suspended particles or debris within a fluid, such as a liquid, for example, and further including a particulate filter integrated with the centrifugal separator.

The centrifugal separator may include a cylindrical body having an inlet pipe for directing the fluid generally tangentially into the cylindrical body, causing the fluid to spin around the inside diameter of the cylindrical body. An outlet pipe, which may have a diameter smaller than the inside diameter of the cylindrical body, may extend with a first end outside a top end of the cylindrical body and a second end extending, generally concentrically, into the cylindrical body. Directional blades may be disposed on an outer surface of the outlet pipe, with a gap between the directional blades and the inside surface of the cylindrical body. A baffle dome disposed on a lower end of the cylindrical body slows down the fluid flow, causing the particles and debris to remain below the baffle and settle. The fluid then exits out the outlet pipe as a cleaned fluid.

The particulate filter may include a cylindrical body, having an inlet pipe receiving the flow of the fluid from the outlet pipe the centrifugal separator. The particulate filter may further include a filter body. The filter body may include a mesh, a screen, or other filtering device useful for retraining particles above a selected size from passing through the filter body. The filter body may be cone-shaped and oriented with a narrow portion of the cone shape oriented in an upward direction. The filter body may segment the particulate filter into two sections, with fluid being received into a first section and with the fluid flowing through the filter body to enter the second section. The inlet pipe may enter the particulate filter in the first section and may direct the flow of fluid from the centrifugal separator into a wider portion of the cone shape from below. An outlet pipe of the particulate filter may be above the filter body in the second section, such that after the fluid flows through the filter body, it exits the particulate filter through the outlet pipe. The cone shape of the filter body with the narrow portion being oriented in the vertically upward direction means that any particles captured or filtered from the fluid upon the filter body may fall downward from the filter body. The particles that fall from the filter body may collect upon a bottom surface of the particulate filter to be collected later.

Use of the centrifugal separator and the particulate filter may be complimentary. For example, the centrifugal separator may provide excellent particle separation for suspended particles of a certain size and/or a certain particle density. Other particles of a different size or density may tend to pass through the centrifugal separator with a greater occurrence. A mesh size of the filter body in the particulate filter may be selected based upon capturing or filtering out particles tend to pass by the centrifugal separator. Additionally or alternatively, the filter body may be adjusted or selected based upon properties of the fluid (viscosity, temperature, composition, etc.), overall system requirements (minimum flow rate, sensitivity to particulate matter, time passed since last maintenance operation, etc.), or other similar considerations. The filter body may be replaceable or capable of being switched out or adjusted, such that a user may test or observe whether particles are getting past the filter body (indicating that the mesh size is too large) or that flow resistance in the particulate filter is too high (indicating that the mesh size is too small). In one embodiment, performance of the centrifugal separator may change based upon changing factors such as flow rate and temperature, and the filter body may be changed as the factors change.

Cyclonic separation is a method of removing particulates from an air, gas or fluid stream, without the use of filters, through vortex separation. Rotational effects and gravity are used to separate mixtures of solids and liquids.

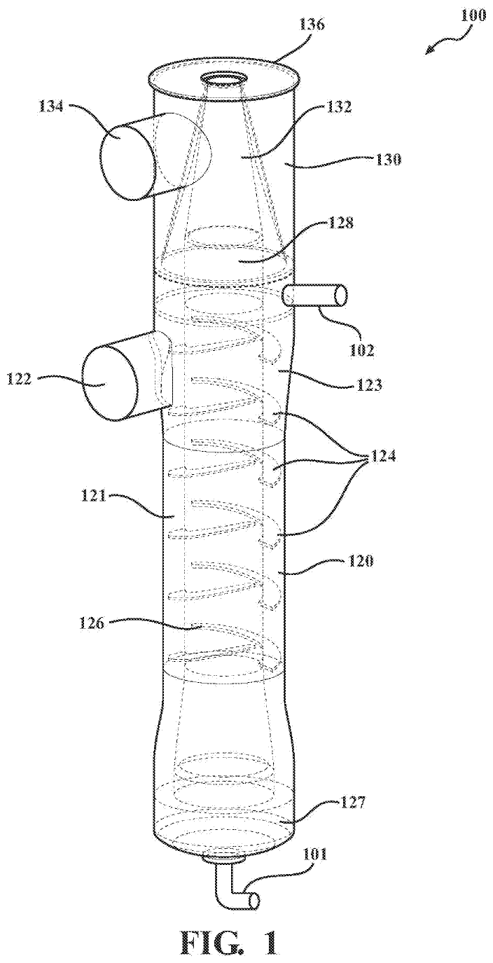

Referring now to the drawings, wherein like reference numbers refer to like features throughout the several views, FIG. 1 illustrates an exemplary system 100 including a centrifugal separator 120 that provides mechanical separation of suspended particles or debris within a fluid and a particulate filter 130. The centrifugal separator 120 is illustrated including a cylindrical body 121, an inlet pipe 122, and an outlet pipe 128. The inlet pipe 122 is illustrated offset from a center of the cylindrical body 121, such that an initial velocity of the fluid flowing into the cylindrical body 121 flows along a curved inner surface 123 of the cylindrical body 121 causing the fluid to form a swirling flow within the cylindrical body 121. Additionally, blades 124 are illustrated disposed within the cylindrical body 121 to channel the swirling fluid downward within the cylindrical body 121. A discharge pipe 126 is illustrated disposed within the cylindrical body 121, with the blades 124 being disposed about an outer surface of the discharge pipe 126. As the fluid swirls downward and reaches a lower end of the discharge pipe 126, the fluid changes direction and flows along an inside diameter of the discharge pipe 126 upwardly until the fluid exits the centrifugal separator 120 through an outlet pipe 128.

The swirling movement of the fluid within the cylindrical body 121 causes solid particulates to accumulate along the inner surface 123 of the cylindrical body 121 due to centrifugal force. As the fluid changes direction to go up the inner diameter of the discharge pipe 126, the particulate matter tends to separate from the flow and fall into a bottom portion 127 of the centrifugal separator 120, where the particulate matter may be collected. In one embodiment, the centrifugal separator 120 may provide excellent separation of relatively larger or more massive solid particles from the flow, while the centrifugal separator 120 may permit some percentage or portion of relatively smaller or less massive solid particles within the flow to flow out of the centrifugal separator 120 with the flow.

Attached or disposed to a top portion of the centrifugal separator 120, the particulate filter 130 is illustrated configured to receive the flow of the fluid from the outlet pipe 128. The particulate filter may alternatively be described as a secondary screen, a cone filter, a particulate mesh, or a basket strainer. The particulate filter 130 is illustrated including a filter body 132 and a system outlet pipe 134. The filter body 132 may include a filter medium, such as a mesh or a perforated plate. Holes or apertures in the filter body 132 may be selectively sized to filter out solid particulates from the flow of a certain size range. A plurality of alternative filter bodies 132 may be provided, such that a user may select between the filter bodies 132 depending upon a filtration effect desired. If a mesh size of the filter body 132 is too high, the particulate filter 130 will provide a flow from the system outlet pipe 134 with more relatively small solid particles than may be desirable. If the mesh size of the filter body 132 is too low, the particulate filter 130 will create an undesirably high flow restriction and/or may clog sooner than desired. In one embodiment, the filter body 132 with a desirable mesh size may be selected based upon performance of the centrifugal separator 120, for example, by sampling what size and what quantity of solid particulates are permitted to exit the centrifugal separator 120 during operation. In another embodiment, the filter body 132 with a desirable mesh size may be selected based upon tolerances and specifications of machinery receiving the flow of filtered fluid from the system outlet pipe 134.

The particulate filter 130 may include a removable lid 136 enabling a user to change or clean the filter body 132. The lid 136 may be securable by latch, threaded interface, or by other securing means.

The system 100 of FIG. 1 is further illustrated including a first purge line 101 and a second purge line 102. The first purge line 101 is located connected to the bottom portion 127 of the centrifugal separator 120. As particulate matter is separated from the fluid within the centrifugal separator 120, the particulate matter may fall within the bottom portion 127 and come to rest or gather within the bottom portion 127. The particulate matter may periodically be purged from the system. In one embodiment, a valve may be attached to the first purge line 101 such that the valve may be periodically opened to permit fluid rich with the particulate matter to escape for disposal. Similarly, as particulate matter is separated from the fluid and collects within the particulate filter in an area below the filter body 132, a valve attached to the second purge line 102 may be periodically opened to permit fluid rich with the particulate matter to escape for disposal.

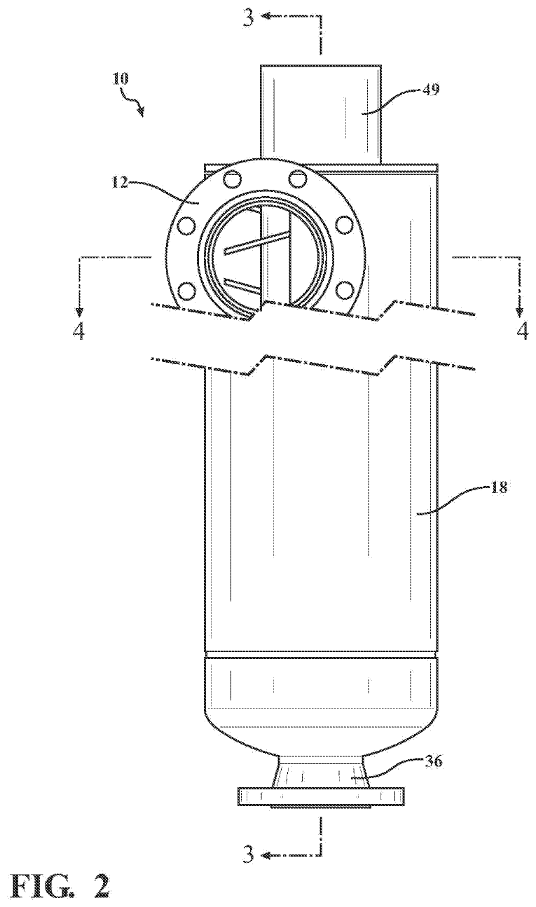

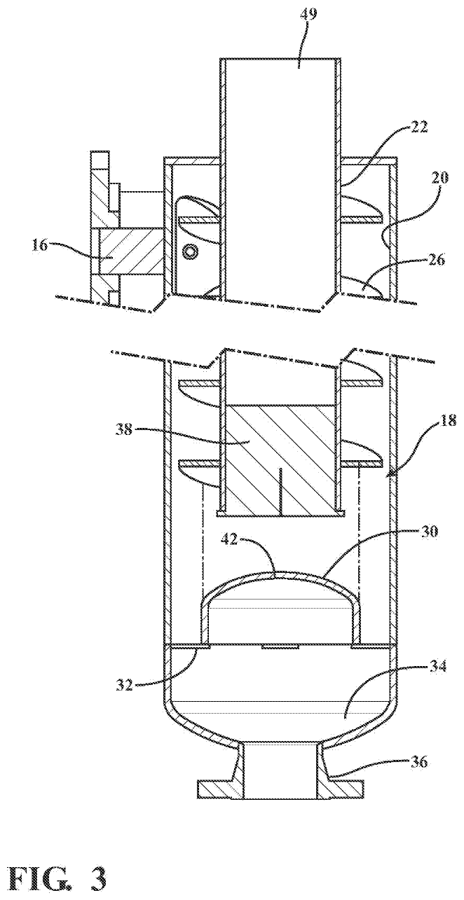

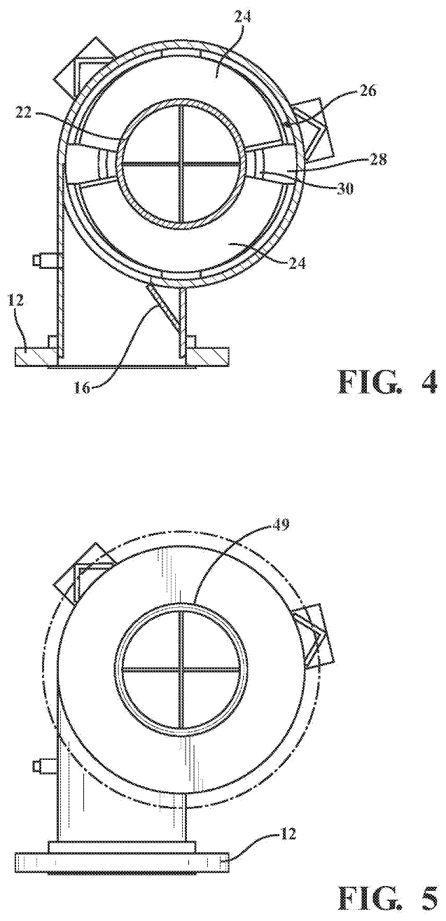

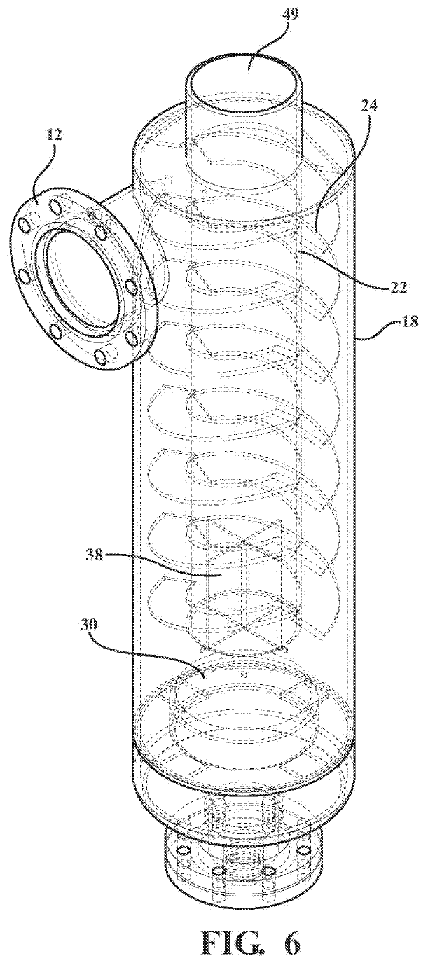

Centrifugal separators may include alternative configurations. FIG. 2 schematically illustrates in side view an alternative centrifugal separator 10. FIG. 2 defines a first cross-sectional view 3 for FIG. 3 and a second cross-sectional view 4 for FIG. 4. FIG. 3 schematically illustrates the centrifugal separator 10 of FIG. 2 in front cross-sectional view. FIG. 4 schematically illustrates the centrifugal separator 10 of FIG. 2 in top cross-sectional view. FIG. 5 schematically illustrates the centrifugal separator 10 of FIG. 2 in top view. FIG. 6 schematically illustrates the centrifugal separator 10 of FIG. 2 in perspective view.

Referring to FIGS. 2 through 6, the alternative centrifugal separator 10 may include an inlet port 12 and an outlet pipe 49. Fluid may be received into the inlet port 12. A reduction baffle 16 may be disposed within the inlet port 12 to reduce the size of the inlet port 12, causing an increase in fluid velocity. The reduction baffle 16 may be sized and shaped in various manners, depending on the specific application. In some embodiments, the reduction baffle 16 may be adjustable to help optimize the velocity of the fluid entering a body 18 of the centrifugal separator 10. The inlet port 12 may be flanged, threaded, grooved, or the like, for connection to flow inlets and flow outlets of an overall fluid processing system.

The inlet port 12 is attached to the body 18 of the centrifugal separator 10 in such a way that the fluid flow is introduced at an angle that is generally tangential to an inside wall 20 of the body 18.

The outlet pipe 49 may be an upper portion of a discharge pipe 22. The discharge pipe 22 extends from the outlet pipe 49, into the body 18 of the centrifugal separator 10. The outside diameter of the discharge pipe 22 is smaller than the inside diameter of the body 18 of the centrifugal separator 10. Typically, a three nominal pipe diameter difference is used between the body 18 of the centrifugal separator 10 and the discharge pipe 22 for body sizes of 10 inches or less. When the body size is greater than 10 inches, the body 18 may be shortened (reducing the number of spins) or there may be a four nominal pipe diameter difference between the body 18 and the discharge pipe 22. For example, if the body 18 of the centrifugal separator 10 is formed from 6-inch pipe, the discharge pipe 22 may be sized from 3-inch pipe. Nominal pipe diameters include ½-inch, ¾-inch, 1-inch, 1.25-inch, 1.5-inch, 2-inch, 3-inch, 4-inch, 5-inch, 6-inch, 8-inch, 10-inch and the like. Depending upon the specific application, the difference in sizes between the discharge pipe 22 and the body 18 of the centrifugal separator 10 may be greater or less than three nominal pipe sizes.

Fluid entering the inlet port 12 spins about the inside wall 20 of the centrifugal separator 10. A plurality of blades 24 may be attached to the discharge pipe 22 and extend outward therefrom toward the inside wall 20 of the body 18. The blades 24 may prevent fluid from taking the path of least resistance down the inside of the body while maintaining the spinning of the fluid. This spinning uses centrifugal force to direct particles or debris to the inside wall 20, where fluid velocity is faster.

A gap 26 may be maintained between the blades 24 and the inside wall 20. The gap 26 may be from about ¼ to about 1 inch, typically about ½ inch. The gap 26 may allow large particles to migrate down the inside wall 20 of the body 18.

The blades 24 may be disposed on opposite sides of the discharge pipe 22, with a blade gap 28 formed along the course of the blades 24. In other words, the blades 24 may form a discontinuous spiral along a length of the discharge pipe 22. However, in some embodiments, the blades 24 may be formed in a continuous spiral along the discharge pipe 22. The blades 24 may be disposed at an angle relative to a longitudinal axis of the discharge pipe 22. This angle may be from about 5 to about 25 degrees, typically about 15 degrees.

As shown best in FIG. 2, the discharge pipe 22 may terminate above a baffle dome 30 disposed at a bottom of the body 18. Typically, the discharge pipe 22 may terminate a distance from about 10% to about 100% of the diameter of the body 18 away from the top of the baffle dome 30. The baffle dome 30 may have a diameter greater than a diameter of the discharge pipe 22, but smaller than a diameter defined by an outer edge of the blades 24. FIG. 2 shows, for example, the baffle dome 30 having a diameter formed from a midpoint of the blades 24. In some embodiments, the baffle dome 30 may have a diameter that is two nominal pipe sizes larger in diameter from the discharge pipe 22. The diameter and height of the baffle dome 30 may vary depending on application. A plurality of legs 32, typically four legs 32, may extend from the inside wall 20 of the body 18 to the bottom of the baffle dome 30. Spaces between the legs 32 allow particles and debris to fall to a collection zone 34 of the centrifugal separator 10. The collection zone 34 may be formed in a frusto-conical shape to guide particles and debris to a drain 36 at the bottom of the centrifugal separator 10.

When the faster fluid is carried down the body 18 below the baffle dome 30, it slows down, causing the particles and debris to remain the baffle dome 30 and settle. The drain 36 may be purged as needed to remove particles and debris from the centrifugal separator 10. Slower, cleaner fluid is allowed to exit the centrifugal separator 10 through the discharge pipe 22 above the baffle dome 30.

When the slower, cleaner fluid enters the discharge pipe 22, it may encounter one or more flow straightening veins 38. The straightening veins 38 may be disposed within the discharge pipe 22, typically at a bottom, open end thereof. The straightening veins 38 may be formed in various sizes and shapes and may extend various lengths into the discharge pipe 22. In one embodiment, the straightening veins 38 may be formed as two planar members, disposed orthogonally to one another within the discharge pipe 22, extending about one pipe diameter (of the discharge pipe 22) into the discharge pipe 22. The straightening veins 38 may prevent spinning of fluid entering the discharge pipe 22, allowing a straight flow to be achieved.

The discharge pipe 22 may exit the centrifugal separator 10 at a top portion thereof and terminates as outlet pipe 49.

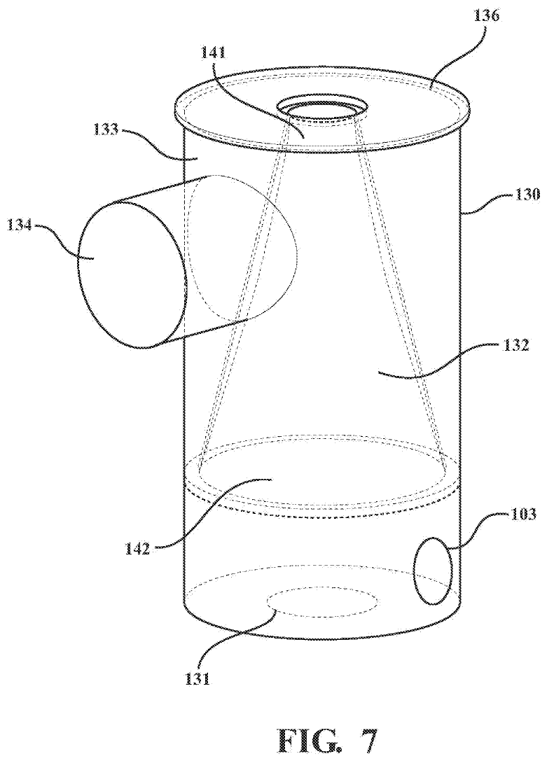

FIG. 7 schematically illustrates in perspective view the particulate filter 130 of FIG. 1. The particulate filter 130 is illustrated including a body portion 133, the filter body 132, and a system outlet pipe 134. The body portion 133 of the particulate filter 130 is exemplary and may include different shapes. The filter body 132 is exemplary and may include different shapes. The filter body 132 is illustrated as a conical shape including a narrow end 141 and a wide end 142 fitting within a cylindrically shaped body portion 133. The particulate filter 130 is illustrated including an inlet 131 configured for receiving the outlet pipe 128 of FIG. 1. A port 103 is illustrated for connection of the second discharge line 102 of FIG. 1.

The particulate filter 130 may include the removable lid 136 enabling a user to change or clean the filter body 132. The lid 136 may be securable by latch, threaded interface, or by other securing means.

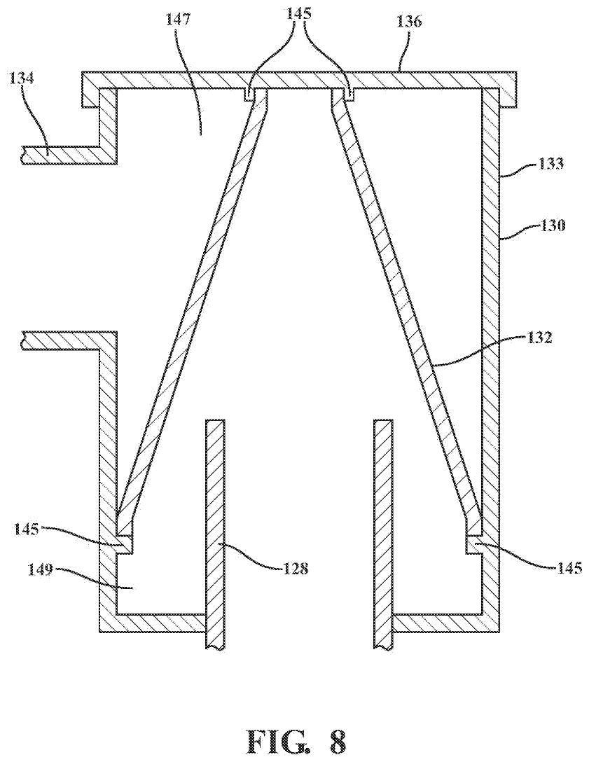

FIG. 8 schematically illustrates in cross sectional view the particulate filter 130 of FIG. 7. The particulate filter 130 is illustrated including the filter body 132 within the body portion 133. The particulate filter 130 may be described as including two portions, a first portion 149 below the filter body 132 and a second portion 147 above the filter body 132. As the flow enters the particulate filter 130 through the outlet pipe 128, the flow enters the first portion 149. The flow passes through the filter body 132 to enter the second portion 147. As the flow passes through the filter body 132, the flow is filtered, with solid particles larger than a mesh size of the filter body 132 accumulating upon a bottom side of the filter body 132. The solid particles may be retained upon the filter body 132, or the solid particles may fall downwardly and collect within a bottom of the first portion 149 for later collection. The flow continues through the second portion 147 and exits the particulate filter 130 through the system outlet pipe 134.

The particulate filter 130 is illustrated including filter body retention features 145 formed upon the lid 136 and upon sidewalls of the body portion 133. The filter body retention features 145 are exemplary and may include different particular features based upon a shape of the body portion 133 and a shape of the filter body 132.

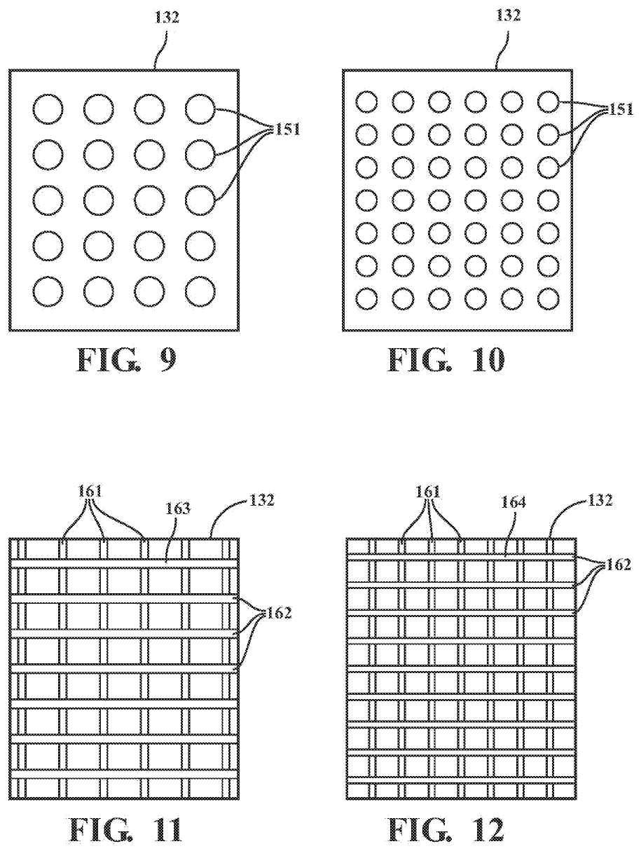

The filter body 132 may include a variety of filter or mesh configurations. FIGS. 9-12 schematically illustrate exemplary surfaces of the filter body 132. FIG. 9 schematically illustrates the filter body 132 including a plate with a plurality of edge surfaces 151, each edge surface 151 defining a relatively large perforation or through-hole through which a fluid may pass. FIG. 10 schematically illustrates the filter body 132 including a plate with a plurality of edge surfaces 151, each edge surface 151 defining a relatively small perforation or through-hole through which a fluid may pass. The filter body 132 may include relatively large or relatively small through-holes, and alternative filter bodies 132 may be utilized.

FIG. 11 schematically illustrates the filter body 132 including a screen including a cross-hatch pattern of wires 161 oriented in a first direction and wires 162 oriented in a second direction. A plurality of wire edge surfaces 163 are illustrated, each wire edge surface 163 defining a relatively large mesh opening through which a fluid may pass. FIG. 12 schematically illustrates the filter body 132 including a screen including a cross-hatch pattern of wires 161 oriented in a first direction and wires 162 oriented in a second direction. A plurality of wire edge surfaces 164 are illustrated, each wire edge surface 164 defining a relatively small mesh opening through which a fluid may pass. The filter body 132 may include relatively large or relatively small mesh openings, and alternative filter bodies 132 may be utilized.

The disclosed system may be described as filtering particulate matter or particles from a fluid flow in two stages. In one embodiment, the first stage, the centrifugal separator may be described as separating out a first portion of the particles from the fluid flow. The second stage, the particulate filter, may be described as separating out a second portion of the particles from the fluid flow. The system may be configured such that the first stage tends to remove one classification of the particles, and the second stage may tend to remove a second classification of the particles. For instance, the first stage may tend to remove larger particles or particles having greater mass, whereas the second stage may be configured for removing smaller particles or particles having smaller mass. The portion of the particles that the stages tend to remove may be selectable. For instance, a velocity of the fluid moving through the centrifugal separator may affect what types of particles are separated out by the centrifugal separator. In another embodiment, the blades within the centrifugal separator may be replaceable or selected at time of manufacture for particular, desired operation of the centrifugal separator. Similarly, a mesh size of the filter body may affect what types of particles are separated out by the particulate filter. A user may study an affect of particles in the fluid flow upon other equipment that comes in contact with the fluid flow. The user may additionally evaluate how often the purge lines may reasonably be purged. Operation of the disclosed system may be modulated based upon tolerances of the related equipment and tolerance of the user for operating frequent purging events.

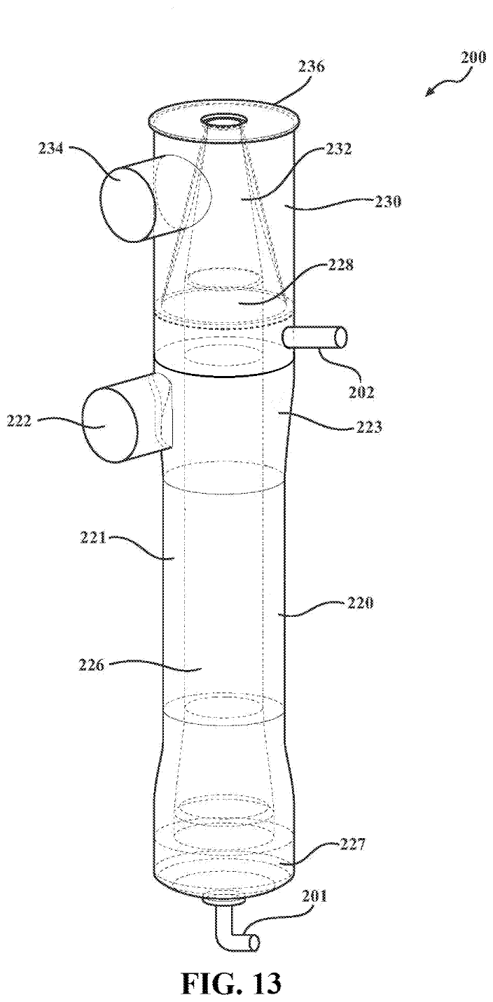

FIG. 13 schematically illustrates an exemplary alternative system 200 including a centrifugal separator 220 that provides mechanical separation of suspended particles or debris within a fluid and a particulate filter 230, wherein the centrifugal 220 separator is free of internal blades. The centrifugal separator 220 is illustrated including a cylindrical body 221, an inlet pipe 222, and an outlet pipe 228. The inlet pipe 222 is illustrated offset from a center of the cylindrical body 221, such that an initial velocity of the fluid flowing into the cylindrical body 221 flows along a curved inner surface 223 of the cylindrical body 221 causing the fluid to form a swirling flow within the cylindrical body 221. A discharge pipe 226 is illustrated disposed within the cylindrical body 221. As the fluid swirls downward and reaches a lower end of the discharge pipe 226, the fluid changes direction and flows along an inside diameter of the discharge pipe 226 upwardly until the fluid exits the centrifugal separator 220 through an outlet pipe 228.

The swirling movement of the fluid within the cylindrical body 221 causes solid particulates to accumulate along the inner surface 223 of the cylindrical body 221 due to centrifugal force. As the fluid changes direction to go up the inner diameter of the discharge pipe 226, the particulate matter tends to separate from the flow and fall into a bottom portion 227 of the centrifugal separator 220, where the particulate matter may be collected. In one embodiment, the centrifugal separator 220 may provide excellent separation of relatively larger or more massive solid particles from the flow, while the centrifugal separator 220 may permit some percentage or portion of relatively smaller or less massive solid particles within the flow to flow out of the centrifugal separator 220 with the flow.

Attached or disposed to a top portion of the centrifugal separator 2120, the particulate filter 230 is illustrated configured to receive the flow of the fluid from the outlet pipe 228. The particulate filter may alternatively be described as a secondary screen, a cone filter, a particulate mesh, or a basket strainer. The particulate filter 230 is illustrated including a filter body 232 and a system outlet pipe 234. The filter body 232 may include a filter medium, such as a mesh or a perforated plate. Holes or apertures in the filter body 232 may be selectively sized to filter out solid particulates from the flow of a certain size range. A plurality of alternative filter bodies 232 may be provided, such that a user may select between the filter bodies 232 depending upon a filtration effect desired. If a mesh size of the filter body 232 is too high, the particulate filter 230 will provide a flow from the system outlet pipe 234 with more relatively small solid particles than may be desirable. If the mesh size of the filter body 232 is too low, the particulate filter 230 will create an undesirably high flow restriction and/or may clog sooner than desired. In one embodiment, the filter body 232 with a desirable mesh size may be selected based upon performance of the centrifugal separator 220, for example, by sampling what size and what quantity of solid particulates are permitted to exit the centrifugal separator 220 during operation. In another embodiment, the filter body 232 with a desirable mesh size may be selected based upon tolerances and specifications of machinery receiving the flow of filtered fluid from the system outlet pipe 234.

The particulate filter 230 may include a removable lid 236 enabling a user to change or clean the filter body 232. The lid 236 may be securable by latch, threaded interface, or by other securing means.

The system 200 of FIG. 13 is further illustrated including a first purge line 201 and a second purge line 202. The first purge line 201 is located connected to the bottom portion 227 of the centrifugal separator 220. As particulate matter is separated from the fluid within the centrifugal separator 220, the particulate matter may fall within the bottom portion 227 and come to rest or gather within the bottom portion 227. The particulate matter may periodically be purged from the system. In one embodiment, a valve may be attached to the first purge line 201 such that the valve may be periodically opened to permit fluid rich with the particulate matter to escape for disposal. Similarly, as particulate matter is separated from the fluid and collects within the particulate filter in an area below the filter body 232, a valve attached to the second purge line 202 may be periodically opened to permit fluid rich with the particulate matter to escape for disposal.

While the best modes for carrying out the disclosure have been described in detail, those familiar with the art to which this disclosure relates will recognize various alternative designs and embodiments for practicing the disclosure within the scope of the appended claims.

What is claimed is:

1. A system for mechanical separation of a fluid, the system comprising:
a centrifugal separator configured for receiving a flow of the fluid including a plurality of solid particles and utilizing centrifugal force to separate a first portion of the plurality of solid particles from the flow of the fluid; and
a particulate filter including a filter body, wherein the particulate filter is configured for receiving the flow of the fluid from the centrifugal separator and utilizing the filter body to separate a second portion of the plurality of solid particles from the flow of the fluid.

2. The system of claim 1, wherein the centrifugal separator is configured for separating the first portion of the plurality of solid particles from the flow with relatively large particle sizes; and
wherein the particulate filter is configured for separating the second portion of the plurality of solid particles from the flow with relatively small particle sizes which are smaller than the relatively large particle sizes.

3. The system of claim 1, wherein the centrifugal separator is configured for separating the first portion of the plurality of solid particles from the flow with relatively large masses; and
wherein the particulate filter is configured for separating the second portion of the plurality of solid particles from the flow with relatively small masses which are smaller than the relatively large masses.

4. The system of claim 1, wherein the particulate filter is configured for enabling a user to switch from using one filter body within the particulate filter to using a second filter body within the particulate filter.

5. The system of claim 1, wherein the filter body is conical shaped; and
wherein the filter body is oriented with a narrow end of the filter body in a vertically upward direction.

6. The system of claim 5, wherein the filter body defines a first portion of the particulate filter below the filter body and a second portion of the particulate filter above the filter body; and
wherein the particulate filter is configured for receiving the flow of the fluid within the first portion of the particulate filter.

7. The system of claim 1, wherein the centrifugal separator includes:
a cylindrical body;
an inlet pipe offset from a center of the cylindrical body and configured for creating a swirling pattern in the flow of the fluid within the cylindrical body;
a discharge pipe including a first end located within the cylindrical body and a second end projecting out of the cylindrical body and defining an outlet pipe of the centrifugal separator; and
a plurality of blades disposed upon an outer surface of the discharge pipe and configured for directing the flow of the fluid from the inlet pipe to the first end of the discharge pipe; and
wherein the particulate filter is attached to the outlet pipe.

8. The system of claim 1, wherein the centrifugal separator includes a discharge pipe configured for periodically purging the first portion of the plurality of solid particles from the centrifugal separator.

9. The system of claim 1, wherein the particulate filter includes a discharge pipe configured for periodically purging the second portion of the plurality of solid particles from the particulate filter.

10. A system for mechanical separation of a fluid, the system comprising:
a centrifugal separator configured for receiving a flow of the fluid including a plurality of solid particles and utilizing centrifugal force to separate a first portion of the plurality of solid particles from the flow of the fluid, wherein the centrifugal separator includes:
a cylindrical body;
an inlet pipe offset from a center of the cylindrical body and configured for creating a swirling pattern in the flow of the fluid within the cylindrical body;
a discharge pipe including a first end located within the cylindrical body and a second end projecting out of the cylindrical body and defining an outlet pipe of the centrifugal separator; and
a plurality of blades disposed upon an outer surface of the discharge pipe and configured for directing the flow of the fluid from the inlet pipe to the first end of the discharge pipe; and
a particulate filter including a filter body, wherein the particulate filter is configured for receiving the flow of the fluid from the centrifugal separator and utilizing the filter body to separate a second portion of the plurality of solid particles from the flow of the fluid; and
wherein the filter body is conical shaped; and
wherein the filter body is oriented with a narrow end of the filter body in a vertically upward direction.

11. The system of claim 10, wherein the filter body defines a first portion of the particulate filter below the filter body and a second portion of the particulate filter above the filter body; and
wherein the particulate filter is configured for receiving the flow of the fluid within the first portion of the particulate filter.

12. The system of claim 10, wherein the centrifugal separator is configured for separating the first portion of the plurality of solid particles from the flow with relatively large particle sizes; and
wherein the particulate filter is configured for separating the second portion of the plurality of solid particles from the flow with relatively small particle sizes which are smaller than the relatively large particle sizes.

13. The system of claim 10, wherein the centrifugal separator is configured for separating the first portion of the plurality of solid particles from the flow with relatively large masses; and
wherein the particulate filter is configured for separating the second portion of the plurality of solid particles from the flow with relatively small masses which are smaller than the relatively large masses.

14. The system of claim 10, wherein the particulate filter is configured for enabling a user to switch from using one filter body within the particulate filter to using a second filter body within the particulate filter.

15. A system for mechanical separation of a fluid, the system comprising:
a centrifugal separator configured for receiving a flow of the fluid including a plurality of solid particles and utilizing centrifugal force to separate a first portion of the plurality of solid particles from the flow of the fluid; and
a particulate filter including a filter body, wherein the particulate filter is configured for receiving the flow of the fluid from the centrifugal separator and utilizing the filter body to separate a second portion of the plurality of solid particles from the flow of the fluid; and
wherein the centrifugal separator is configured for separating the first portion of the plurality of solid particles from the flow with relatively large particle sizes;
wherein the particulate filter is configured for separating the second portion of the plurality of solid particles from the flow with relatively small particle sizes which are smaller than the relatively large particle sizes; and
wherein the particulate filter is configured for enabling a user to switch from using one filter body within the particulate filter to using a second filter body within the particulate filter.

16. The system of claim 15, wherein the filter body is conical shaped; and
wherein the filter body is oriented with a narrow end of the filter body in a vertically upward direction.

17. The system of claim 16, wherein the filter body defines a first portion of the particulate filter below the filter body and a second portion of the particulate filter above the filter body; and
wherein the particulate filter is configured for receiving the flow of the fluid within the first portion of the particulate filter.

18. The system of claim 15, wherein the centrifugal separator includes:
a cylindrical body;
an inlet pipe offset from a center of the cylindrical body and configured for creating a swirling pattern in the flow of the fluid within the cylindrical body;
a discharge pipe including a first end located within the cylindrical body and a second end projecting out of the cylindrical body and defining an outlet pipe of the centrifugal separator; and
a plurality of blades disposed upon an outer surface of the discharge pipe and configured for directing the flow of the fluid from the inlet pipe to the first end of the discharge pipe; and
wherein the particulate filter is attached to the outlet pipe.
